(19) United States
(12) Patent Application Publication
(10) Pub. No.: US 2022/0350809 A1
(43) Pub. Date: Nov. 3, 2022

(54) METHOD AND SYSTEM FOR COMPILING AND UTILIZIING COMPANY DATA TO ADVANCE EQUALITY, DIVERSITY, AND INCLUSION

(71) Applicant: Data Vault Holdings, Inc., New York, NY (US)

(72) Inventors: Nathaniel T. Bradley, Tucson, AZ (US); Alfred Blair Blaikie, III, Tinton Falls, NJ (US); Joshua S. Paugh, Tucson, AZ (US); John F. Carter, McDonough, GA (US); Sonia Choi, Matawan, NJ (US)

(73) Assignee: Data Vault Holdings, Inc., New York, NY (US)

(21) Appl. No.: 17/244,284

(22) Filed: Apr. 29, 2021

(51) Int. Cl. G06F 16/2457; G06F 16/22; G06F 9/46; H04L 9/32; G06Q 10/04

(52) U.S. Cl. CPC G06F 16/24578; G06F 16/2272; G06F 9/466; H04L 9/3213; G06Q 10/04; G06Q 2220/10

(57) ABSTRACT

A system, method, and platform for analyzing company data. Source data regarding one or more companies is captured utilizing a data platform. The source data captured based on criteria including at least equality, diversity, and inclusion associated with the one or more companies is analyzed to generate company data for each of the one or more companies. The one or more companies are scored based on the criteria. The one or more companies are ranked based on the criteria. The company information including at least the scores and ranking from the data platform is communicated to one or more designated parties.

### BACKGROUND

### I. Field of the Disclosure

The illustrative embodiments relate to data management. More specifically, but not exclusively, the illustrative embodiments relate to a system, method, apparatus, and platform for the advancing equality, diversity, and inclusion through management of company data and active feedback.

### II. Description of the Art

In recent years, various diversity, equality, and inclusion issues, problems, and matters have been highlighted. It is often difficult for individuals and companies to determine which companies to invest in and otherwise support based on their standards, policies, practices, culture, and hiring efforts. For example, many people seek to support companies that are diverse and have equal pay provisions for all staff, employees, executives/partners, board members, vendors, and others that perform work on the company's behalf. Many companies “talk big” without taking substantive action. Professing to support equality, diversity, and inclusion efforts is different from actually supporting them through hiring and promotion practices, benefits, implemented company policy, payments, and so forth. Additionally, it is important that actions may be verified through hard data. As a result, it can be hard for investing companies, funds, groups and individual investors to support companies with an authenticated track record with regard to diversity, equality, and inclusion.

### SUMMARY OF THE DISCLOSURE

The illustrative embodiments provide a system, method, and platform for analyzing company data. Source data regarding one or more companies is captured utilizing a data platform. The source data captured based on criteria including at least equality, diversity, and inclusion associated with the one or more companies is analyzed to generate company data for each of the one or more companies. The one or more companies are scored based on the criteria. The one or more companies are ranked based on the criteria. The company information including at least the scores and ranking from the data platform is communicated to one or more designated parties. Another embodiment provides a processor for executing a set of instructions and a memory storing a set of instructions configured to perform the method herein described.

In other embodiments the source data may be captured from public resources and private resources. The company data may be stored in a secure storage for access by authorized parties. The company data may be accessible through any crypto currency token or a non-fungible token. In another embodiment, the company data may be grouped into a data asset, the data asset may be associated with a data platform including one or more servers and databases, transaction information may be received for the data asset, one or more transactions for the data asset may be performed based on the transaction information, the one or more transactions are performed utilizing the data platform, and verification of the transaction are provided for the data asset. An index of at least a portion of the one or more companies may be created based on the company data, scoring, and ranking. Feedback may be provided to the one or more companies to enhance equality, diversity, and inclusion in response to the scoring and the ranking. The feedback suggestions for hiring or more companies one or more companies searched based on company data.

Another embodiment provides a data platform. The data platform includes a server including a processor for executing a set of instructions and a memory for storing the set of instructions. The data platform further includes databases and communications with the server. The set of instructions are executed by the processor for the server to capture source data regarding one or more companies utilizing a data platform, analyze the source data captured based on criteria including at least equality, diversity, and inclusion associated with the one or more companies to generate company data for each of the one or more companies, score the one or more companies based on the criteria, rank the one or more companies based on the criteria, and communicate the company information including at least the scores and ranking from the data platform to one or more designated parties.

The illustrative embodiments provide a system, method, and platform for performing transactions for company data. The company data is grouped. The company data is associated with a platform. Transaction information for the company data is received. One or more transactions are performed based on the transaction information. The verification of the transaction is provided. Another embodiment provides a processor for executing a set of instructions and a memory storing a set of instructions configured to perform the method herein described.

The illustrative embodiments provide a system, method, and platform for monetizing company data. A selection is received from a user to monetize company data associated with the user. The company data associated with user is compiled. A security token is generated including the company data. The company data is monetized utilizing the security token in accordance with the selection.

Another embodiment provides a system, method, and platform for performing transactions for company data. The company data is collected and grouped. The company data is associated with each unique user profile and unique profile data element within the user profile record stored for access and monetization by the platform. Transaction information for the company data is received, tokenized, valued and placed on various data markets for sale to any data acquirers. One or more transactions are performed based on the various proprietary data value methodologies for tokenized data and sales of each data element in each user profile transaction information. The monetization of each data elements is confirmed for each data elements monetized in the transaction and a verification record of the transaction is provided. Another embodiment provides a processor for executing a set of instructions and a memory storing a set of instructions configured to perform the method herein described.

The illustrative embodiments provide a system, method, and platform for tokenizing and monetizing company data. A corporate data profile, data pool or data selection is received to monetize company data associated with one or more companies. The company data associated with the one or more companies is compiled and valued based on the current value of that data based on data completeness or if desired data points are contained in the data profile. A security token is generated based on the data value at the time of data purchase by a 3^{rd} party data purchasers, advertisers or other approved entities that may have a desire to obtain specific commercial and consumer datapoints. The company data is monetized utilizing the security and the value of the data token in accordance with the selection.

In other embodiments, the company data may include digital profiles that are monetized for specific data or as data profile groupings. Data validation may be performed through user platform and profile user opt-ins that are identified and confirmed by the company for the purpose of full control of where company data is accessed and monetized. Token based compensation for company data allows for the direct control and monetization of company data (e.g., hiring practices, equity, diversity, and inclusion information, web data, application data, profiles, personal measurements, health data, financial data, commercial and consumer interest, commercial and consumer purchase intent, readings, corporate data, financial data, accounting data, data pools etc.). Compensation may be performed through digital currencies, hard currencies, charitable contributions, and tax deductions. The one or more companies may be rewarded for additional data uploads, updates, additions, amendments, surveys/questionnaire fulfillment, data point completeness and so forth. The tokens may be utilized to pay a vendor or third party for a product, service, system, or data, secure a digital asset, tracking the life of an asset, share a stake in an asset or company, participate in an initial coin offering, receive a reward, maintaining and managing a digital asset, make a charitable contribution, or receive a tax deduction.

### BRIEF DESCRIPTION OF THE DRAWINGS

Illustrated embodiments are described in detail below with reference to the attached drawing figures, which are incorporated by reference herein, and where:

FIG. 1 is a pictorial representation of a system for managing user data in accordance with an illustrative embodiment;

FIG. 2 further illustrates portions of the system of FIG. 1 in accordance with an illustrative embodiment;

FIG. 3 is a pictorial representation of a platform for monetizing data in accordance with an illustrative embodiment;

FIG. 4 is a flowchart of a process for analyzing data in accordance with an illustrative embodiment;

FIG. 5 is a flowchart of a process for managing data utilization in accordance with an illustrative embodiment;

FIG. 6 is a flowchart of a process for scoring data in accordance with an illustrative embodiment;

FIG. 7 is a flowchart of a process for providing data about a company in accordance with an illustrative embodiment;

FIG. 8 is a flowchart of a process for grouping data in accordance with an illustrative embodiment;

FIG. 9 depicts a computing system in accordance with an illustrative embodiment; and

FIG. 10 is a pictorial representation of a user interface for displaying company information in accordance with an illustrative embodiment.

### DETAILED DESCRIPTION OF THE DISCLOSURE

The illustrative embodiments provide a system, method, platform, and network for processing corporate data to create a weight and rank according to various criteria. In one embodiment, a block chain system may be utilized to capture, analyze, rank, validate, weight, rank, vend, and communicate the corporate data. The illustrative embodiments may be utilized to weigh and rank a corporation's diversity, equality, and inclusion (DEQI), and data, environmental, and social governance (ESG) metrics. The data may be utilized to inform, measure, and quantify investments in companies that match their personal, environmental, and social values related to corporate diversity, inclusion, and a corporation's environmental record.

The illustrative embodiments may provide a counterbalance to known and well recognized indexes that sponsor exchange traded funds (ETFs) focus on unlocking the growing diversity influence and collective financial power of the emerging equality-seeking population. For example, indexes, funds, or other aggregations may be utilized to capture, utilize, and track applicable information. The information, such as the index, may capture the voice of the crowd. The crowd may represent members of various minority and demographic groups (e.g., black equality, Hispanic equality, Asian equality, gender equality, etc.). The crowd may also represent community and business leaders, activists, and watchdogs. The illustrative embodiments involve one or more minority groups prior to implementation of a final securities selection and weighting process. As a result, credibility, involvement, trust, and ownership of the various implementations (e.g., index, recommendations, transactions, etc.) are enhanced. Input, surveys, questionnaires/questions, and/or feedback may be sought at any time to track, manage, and update applicable data for supporting corporate and social change. Poll sizes and feedback may be required to be “statistically significant” for each minority group (e.g., across a country/region/territory specified individuals and age groups). Raw data may be collected, processed, and otherwise analyzed for distribution or redistribution on an information data exchange (i.e., Data Donate Technologies, DDT, etc.).

The illustrative embodiments may produce diversity, equality, and inclusion scores (DEQI) for each company based on all of the applicable data and information. Companies may then be filtered, ranked and weighted. In one embodiment, only the highest DEQI companies may be included in the final index for advanced data analysis. Lower DEQI companies may be tracked and scheduled for corrective action planning.

The illustrative embodiments may implement a diversity and inclusion security selection process to produce an index that is (Regulated Investment Company) RIC compliant, uses public and private data to generate an interim index and reflects purchasing power and social trends. The index may be back tested for various time periods to predict the alpha (excess investor return) over traditional cap weighted indexes. The final index has an alpha in excess of the target beta benchmark over multiple time periods. The final index selection is overlaid against the third party ESG data supplier company list to obtain a final index that is 100% minority preference and ESG compliant. The indexes may be reconstituted annually and rebalanced quarterly as needed or implemented.

The illustrative embodiments may be utilized by financial, insurance, regulatory, technology, governmental, and other individuals, groups, entities, and organizations. The company data may be accessible from any number of authorized and connected devices. The illustrative embodiments allow users/commercial and consumers, commercial and consumer groups, companies, organizations, entities, governments, and other parties worldwide to develop data monetization strategies for company data that enhances equality, diversity, and inclusion using data exchange, indices, funds, investment tools, cryptocurrency tokens, non-fungible tokens, and other financial products and services.

The platform-based conversion of company data for cryptocurrency tokens or non-fungible tokens enables monetization of all types of data into any number of currencies and allows for the price to be set for an anonymous exchange of data through broker transactions. For example, this may include the curation, acquisition, development, creation, and market valuation of secured tokens to protect, monetize, control, and perform transactions with company data. As referenced herein, data refers to the personal, corporate, advertising, commercial and consumer, health, stock, financial, or commercial data, user profiles, web profiles, search profiles, application profiles, accounting, historical data, operational data, live data, incremental data, and other information applicable to a user/employee/executive/board member, commercial and consumer, entity, data vendor, data house, device, system, or other party. The illustrative embodiments comply with all applicable data privacy and administration rules, laws, and best practices. Any number of mobile devices, computers, machines, servers, arrays, or so forth may be utilized to implement the illustrative embodiments. A user may objectify, value, tokenize any profile datapoint contained in his/her data profile and convert and list upon an exchange data objects and enables conversion of all applicable data into data objects that may be controlled, valued, and monetized in commercial exchange transactions.

The illustrative embodiments may be utilized to perform a transaction for the company data. The company data may be grouped, associated to provide present data value and future data value, which may be tokenized and commoditized for any number of trades, exchanges, purchases, donations, or other transactions. The company data may be associated with a platform for transactions involving the data. The transaction may be performed automatically or based on user input, feedback, instructions, or commands.

One embodiment provides a blockchain-based and securitized virtual reality where tokens representing refined data objects are valued within a user interface and that system gives users the ability to control, monetize, and/or choose to make proceeds donatable to charity or causes of their choice. The interface allows user to list any or all of the represented data objects upon a private or public exchange where the company data is represented in a ticker or short name that provides price and object parameters for purchase. The proceeds from the sale of company data are achieved when the ticker is purchased for the sale price, the securitized token is delivered to buyer, and data objects are made available for the buyer's access. The illustrative embodiments of the data refinery provide a curation of data objects that are collected from historical, or in real-time from data sources identified within the system and stored securely as data objects. The valuation of tokenized data objects are priced by the seller using clear compensation and renumeration guidelines and then listed to the exchange via short name or ticker that is made available for purchase to registered buyers.

One embodiment provides a blockchain based security token on non-fungible token system that gives commercial and consumers the ability to control, value, monetize, and/or donate any or all of the proceeds from the utilization, sale, or sharing of their company and profile data. The illustrative embodiments may curate or collect data in real-time from users based on an opt-in system with clear smart contract-based compensation and renumeration guidelines. For example, any number of computing or communications devices, platforms, applications, or so forth may be utilized to capture the company data.

The security tokens utilized may represent any number of existing, custom/proprietary data points and data valuation methodologies, to provide value-based tokens for each user profile-controlled data points in a profile. In one embodiment, formatted, structured, or unstructured data may be converted into or accessed through an encrypted token that represents, includes, or references the applicable company data. The security interest in a company data asset may be represented in the form of a token. Data across numerous fields and with different utilizations may be captured in a token (or tokenized). For example, intelligence, counterintelligence, commercial and consumer profiles, commercial and consumer/user, private, public, and other types of data may be captured and monetized. For example, the illustrative embodiments may provide a data management system that allows an asset, such as ownership of an index, fund, or digital company profile to be tokenized as an asset that may be tracked, grown, and expanded through an opt in submission from multiple sources and monetized digitally through an e-commerce platform.

The illustrative embodiments may also be utilized to create a data index that catalogs company data, user profiles, data sets, and data transactions. The changing values and the future value of the company data may be tracked over time for specific user profiles, commercial and consumer groups, corporations, services, and other similar data pools based on their value to advertisers, data vendors and corporations. The use of security tokens tied to company data and user profiles creates a mechanism to control and value profile, commercial and consumer and corporate data as a marketable asset that gives greater validity to commercial uses of blockchain technologies and the security token market.

Security tokens may be generated by the platform and may utilize custom, established, or traditional blockchain based token mining processes (but is not limited to these methods), for creating the value attributed to each generated token. Non-fungible tokens may also be utilized. Non-fungible tokens are singular wholly unique crypto assets. The non-fungibility of these tokens, unlike bitcoins, makes them irreplaceable and non-interchangeable with another similar asset. If the NFT is a physical asset ownership may be broken down into smaller denominations for shared ownership of an NFT. The token value may be generated from revenue or other incentives provided by investors, banks, investment companies, and others that provide the tokenized value for each token. The tokens may be generated and exchanged for actual currency, preferred stock options, stock warrants, bonds, exchange traded fund (ETF) shares, cryptic or, initial coin offerings (ICO), gift cards, vouchers, and other forms of compensation.

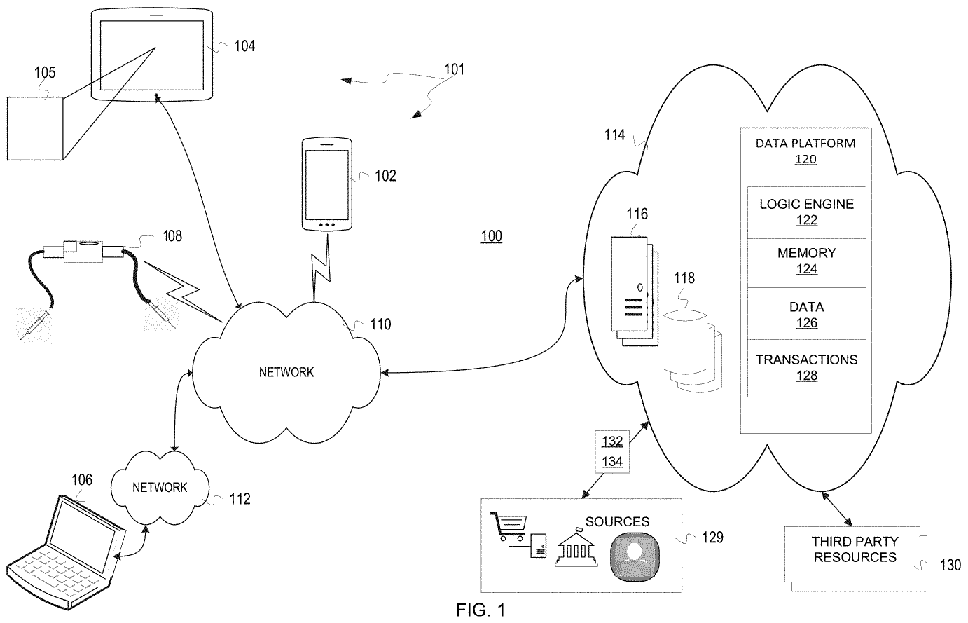

FIG. 1 is a pictorial representation of a system 100 for managing user data in accordance with an illustrative embodiment. In one embodiment, the system 100 of FIG. 1 may include any number of devices 101, networks, components, software, hardware, and so forth. In one example, the system 100 may include a smart phone 102, a tablet 104 displaying graphical user interface 105, a laptop 106 (altogether devices 101), a network 110, a network 112, a cloud system 114, servers 116, databases 118, a data platform 120 including at least a logic engine 122, a memory 124, data 126, and transactions 128. The cloud system 114 may further communicate with sources 129 and third-party resources 130.

Each of the devices, systems, and equipment of the system 100 may include any number of computing and telecommunications components, devices or elements which may include processors, memories, caches, busses, motherboards, chips, traces, wires, pins, circuits, ports, interfaces, cards, converters, adapters, connections, transceivers, displays, antennas, operating systems, kernels, modules, scripts, firmware, sets of instructions, and other similar components and software that are not described herein for purposes of simplicity.

In one embodiment, the system 100 may be utilized by any number of users, organizations, or providers to aggregate, manage, review, analyze, process, tokenize, distribute, advertise, market, display, and/or monetize data 126 (e.g., persona/consumer, commercial, etc.). For example, the data 126 may be utilized in marketing or advertisements for goods or services. In one embodiment, the goods and services represent any number of items, content, products, or services sold by a business, entity, organization, or entity. In one embodiment, the system 100 may utilize any number of secure identifiers (e.g., passwords, pin numbers, certificates, etc.), secure channels, connections, or links, virtual private networks, biometrics, or so forth to upload, manage, and secure the data 126, generate tokens, and perform applicable transactions. As noted, the system 100 may be a blockchain system that utilizes a digital ledger to track transactions involving the data 126 or utilization thereof. For example, the digital ledger may store the transaction details, information, and data. The devices 101 are representative of multiple devices that may be utilized by businesses or commercial and consumers. The devices 101 utilize any number of applications, browsers, gateways, bridges, or interfaces to communicate with the cloud system 114, platform 120, and/or associated components.

The data 126 may include a number of different data types. The data 126 may include demographic data, commercial and consumer data, family and health data, property data, interests and activity data, and other applicable types of data. Demographic data may be a combination of static and influx data points that include age, gender, occupation, marital status, education/education level, income level, religion, birthday, family size, and so forth. Demographic data, although mostly static, is commonly quite important to marketers and other interested parties. Commercial and consumer data may include websites visited, purchase plans, purchases, brand affinity, cars, clothes, travel, and other information applicable to users, clients, customers, groups, or so forth. The family and health data may include permanent or long-lasting data elements which may be helpful for predicting future purchases and include information related to personal, family, health, commercial and consumer purchases, commercial and consumer intentions, and medical conditions, such as child care, diapers, diabetes, incontinence, rental information, and so forth. The family and health data has a large potential for cross marketing of data. Property data may include information regarding ownership, rentals/renters, address, for sale, occupants, pool, and vehicle ownership. This data may be treated and value as static data (even though changes are likely and expected). The interests and activity data may include data regarding hobbies, general interests, product and brand preferences, and other applicable influx data.

The wireless device 102, tablet 104, and laptop 106 are examples of common devices that may be utilized to receive and manage data 126 and perform transactions related thereto. Other examples of devices 101 may include e-readers, cameras, video cameras, audio systems, gaming devices, vehicle systems, kiosks, point of sale systems, televisions, smart displays, monitors, entertainment devices, medical devices, virtual reality/augmented reality systems, or so forth. The devices 101 may communicate wirelessly or through any number of fixed/hardwired connections, networks, signals, protocols, formats, or so forth. In one embodiment, the smart phone 102 is a cell phone that communicates with the network 110 through a 5G connection. The laptop 106 may communicate with the network 112 through an Ethernet, Wi-Fi connection, or other wired or wireless connection.

The data 126 may be collected and sourced from any number of online and real-world sources including, but not limited to, website traffic and cookie-based analytics, social media, social profile, and application data, point of sale, purchase, and transaction history, loyalty programs and coupons, location-based email list for mailers, surveys and questionnaires, and other applicable sources.

These same data collection sources may be utilized to perform valuation of specific data points. In one embodiment, the data 126 may be captured through website traffic and tracking cookie-based analytics. Website traffic is the most common form of marketable data collection and may provide numerous insights and methods to inform and populate a commercial and consumer web profile. This type of data collection may provide countless insights into search engine rank, time spent on a website, page views, clicks, conversions, and so forth which all contribute to site and traffic value. Website and cookie tracking may have static, perennial, and influx data points. The value of each data point may be tracked and measured within a data value index and data derivatives marketplace.

The data 126 may be captured through social media and applications. Social media data may be utilized to provide real-time polls, likes and dislikes, feedback, preferences for media content, site traffic, and numerous other commercial and consumer data. Any number of mobile, computing, personal assistant (e.g., Siri, Alexa, Cortana, Google, etc.), or other applications may be utilized. Social media data may be measured and valued as influx data within the data valuation index and data valuation marketplace.

The data 126 may be captured through point of sale, transaction, and purchase history. The point of sale data may be inherent in most business functions, but may not have been fully monetized in the past. Customers, commercial and consumers, and clients may be comfortable with sharing the specific data points associated with point-of-sale transactions due to est. practices. The point-of-sale transactions may include extensive data, including, but not limited to, name, address, age, gender, brand preference, brand category, product affinity, spending levels, order history, inventory, restock data, purchase demographics, and so forth. Point-of-sale and transaction history data may have static, perennial, and influx data points with the value of each data point being tracked and measured within the data valuation index and the data derivatives marketplace.

The data 126 may also include loyalty programs, memberships, and coupons. Large amounts of commercial and consumer data may be gathered by offering customers, clients, and other incentives for using loyalty cards and coupons. Loyalty programs that connect through a point-of-sale system may provide additional layers of commercial and consumer data collection. The loyalty programs, memberships, and coupons may include static, perennial, and influx data points that are similarly tracked and measured within the data valuation index and the data derivatives marketplace.

The data 126 may also include location-based communications. An example of static and perennial data points that may be collected include a standard web form, email request form, booth, proximity beacons, and so forth. The location-based communications may capture data, such as email, commercial and consumer addresses, phone numbers, and so forth. Location based data may be valued as static or perennial data in the valuation index and data valuation marketplace.

The data 126 may also include surveys and questionnaires. Responses to surveys and questionnaires may be one of the best ways to gather and inform influx commercial and consumer data points. The ability to gather real-world commercial and consumer insights may help complete or round out a user profile. The surveys and questionnaires may be performed digitally (e.g., websites, extensions, programs, applications, browsers, texting, or manually (e.g., audibly, on paper, etc.). Responses to surveys and questionnaires may help achieve saturation of commercial and consumer datapoints for profiles. The survey and questionnaires may be categorized as influx data and may be measured, valued, and traded through a data valuation index and data valuation marketplace.

The cloud system 114 may aggregate, manage, analyze, and process data 126 and tokens across the Internet and any number of networks, sources 129, and third-party resources 130. For example, the networks 110, and 112 may represent any number of public, private, virtual, specialty, or other network types or configurations. The different components of the system 100, including the devices 101 may be configured to communicate using wireless communications, such as Bluetooth, Wi-Fi, or so forth. Alternatively, the devices 101 may communicate utilizing satellite connections, Wi-Fi, 3G, 4G, 5G, LTE, personal communications systems, DMA wireless networks, and/or hardwired connections, such as fiber optics, T1, cable, DSL, high speed trunks, powerline communications, and telephone lines. Any number of communications architectures including client-server, network rings, peer-to-peer, n-tier, application server, mesh networks, fog networks, or other distributed or network system architectures may be utilized. The networks, 110, and 112, of the system 100 may represent a single communication service provider or multiple communications services providers.

The sources 129 may represent any number of web servers, distribution services (e.g., text, email, video, etc.), media servers, platforms, distribution devices, or so forth. In one embodiment, the sources 129 may represent the businesses that purchase, license, or utilize the data 126, such as advertising or marketing goods and services utilizing the system 100. In one embodiment, the cloud system 114 (or alternatively the cloud network) including the data platform 120 is specially configured to perform the illustrative embodiments.

The cloud system 114 or network represents a cloud computing environment and network utilized to aggregate, process, manage, sell, monetize, and distribute data 126 and support the associated transactions and utilization. The cloud system 114 may implement a blockchain system for managing the data 126. The cloud system 114 allows goods and services from multiple businesses, users, managers, or service providers to be centralized. In addition, the cloud system 114 may remotely manage configuration, software, and computation resources for the devices of the system 100, such as devices 101. The cloud system 114 may prevent unauthorized access to data 126, tools, and resources stored in the servers 116, databases 118, and any number of associated secured connections, virtual resources, modules, applications, components, devices, or so forth. In addition, a user may more quickly upload, aggregate, process, manage, and distribute data 126 (e.g., profiles, updates, surveys, content, etc.) where authorized, utilizing the cloud resources of the cloud system 114 and data platform 120. In addition, the cloud system 114 facilitates distribution of data 126 for one or more tax benefits, charitable causes, transactions, or other implementations. The cloud system 114 allows the overall system 100 to be scalable for quickly adding and removing users, businesses, authorized sellers, cause-based information, analysis modules, distributors, valuation logic, algorithms, moderators, programs, scripts, filters, transaction processes, distribution partners, or other users, devices, processes, or resources. Communications with the cloud system 114 may utilize encryption, secured tokens, secure tunnels, handshakes, secure identifiers (e.g., passwords, pins, keys, scripts, biometrics, etc.), firewalls, digital ledgers, specialized software modules, or other data security systems and methodologies as are known in the art. The platform is used as a vault for personal, user profile, corporate data and data pools that secure the data from standard internet profiling and targeting methods through the use of VPN's, secure networks, firewalls and internet data encryption methodologies that ensure the vaulted data cannot be accessed without user profile permission. The cryptographic tokens that are generated in exchange for data storage and access represent a set of rules, encoded in a smart contract that ties the token contract to specific requirements to grant or deny access to each user or data point contained in a data profile.

Although not shown, the cloud system 114 may include any number of load balancers. The load balancer is one or more devices configured to distribute the workload of processing the uploaded data 126 as well as applicable transactions to optimize resource utilization, throughput, and minimize response time and overload. For example, the load balancer may represent a multilayer switch, database load balancer, or a domain name system server. The load balancer may facilitate communications and functionality (e.g. database queries, read requests, write requests, command communications, stream processing, etc.) between the devices 101 and the cloud system 114. For example, the cloud system 114 may offload verification of users that seek to be added to the system 100 along with applicable data 126 and information. Load balancing may be performed between automatic systems and devices as well as individual users. Other intelligent network devices may also be utilized within the cloud system 114.

The servers 116 and databases 118 may represent a portion of the data platform 120. In one embodiment, the servers 116 may include a web server utilized to provide a website, mobile applications, and user interface (e.g., user interface 107) for interfacing with numerous users. Information received by the web server 117 may be managed by the data platform 120 managing the servers 116 and associated databases 118. For example, the web server 117 may communicate with the database 118 to respond to read and write requests. For example, the servers 116 may include one or more servers dedicated to implementing and recording blockchain transactions and communications involving the data 126. For example, the databases 118 may store a digital ledger for updating information relating to the user's data 126 as well as utilization of that data 126. The databases 118 may utilize any number of database architectures and database management systems (DBMS) as are known in the art. The databases 118 may store the content associated with each user/commercial and consumer/purchaser which may specify an address, name, age, demographics, interests, family/friend information, biometric identifiers, payment information, permissions, settings, location, cause preferences, cause restrictions, and so forth. Any number of secure identifiers, such as tones, QR codes, serial numbers, or so forth may be utilized to ensure that content, personal, or transaction information is not improperly shared or accessed.

The user interface 105 may be made available through the various devices 101 of the system 100. In one embodiment, the user interface 105 represents a graphical user interface, audio interface, or other interface that may be utilized to manage data and information. For example, the user may enter or update associated data utilizing the user interface 105 (e.g., browser or application on a mobile device). The user interface 105 may be presented based on execution of one or more applications, browsers, kernels, modules, scripts, operating systems, or specialized software that is executed by one of the respective devices 101. The user interface may display current and historical data as well as trends. The user interface 105 may be utilized to set the user preferences, parameters, and configurations of the devices 101 as well as upload and manage the data, content, and implementation preferences sent to the cloud system 114.

In one embodiment, the system 100 or the cloud system 114 may also include the data platform 120 which is one or more devices utilized to enable, initiate, generate, aggregate, analyze, process, and manage data 126, transactions 128, and so forth with one or more communications or computing devices. The data platform 120 may include one or more devices networked to manage the cloud network and system 114. For example, the data platform 120 may include any number of servers, routers, switches, or advanced intelligent network devices. For example, the data platform 120 may represent one or more web servers that performs the processes and methods herein described.

In one embodiment, the logic engine 122 is the logic that controls various algorithms, programs, hardware, and software that interact to receive, aggregate, analyze, rank, process, score, communicate, and distribute data, content, transactions, alerts, reports, messages, or so forth. The logic engine 122 may utilize any number of thresholds, parameters, criteria, algorithms, instructions, or feedback to interact with users and interested parties and to perform other automated processes. The logic engine 122 may represent a processor. The processor is circuitry or logic enabled to control execution of a program, application, operating system, macro, kernel, or other set of instructions. The processor may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks. The processor may be a single chip or integrated with other computing or communications elements.

The memory 124 is a hardware element, device, or recording media configured to store data for subsequent retrieval or access at a later time. The memory 124 may be static or dynamic memory. The memory 124 may include a hard disk, random access memory, cache, removable media drive, mass storage, or configuration suitable as storage for data 126, transactions 128, instructions, and information. In one embodiment, the memory 124 and logic engine 122 may be integrated. The memory 124 may use any type of volatile or non-volatile storage techniques and mediums. In one embodiment, the memory 124 may store a digital ledger and tokens for implementing blockchain processes.

In one embodiment, the cloud system 114 or the data platform 120 may coordinate the methods and processes described herein as well as software synchronization, communication, and processes. The third-party resources 130 may represent any number of human or electronic resources utilized by the cloud system 114 including, but not limited to, businesses, entities, organizations, individuals, government databases, private databases, web servers, research services, and so forth. For example, the third-party resources 130 may represent advertisement agencies, marketers, e-commerce companies, and others that pay for rights to use the data 126.

In one embodiment, the data platform 120 may implement a blockchain ledger, manager, or technology. In another embodiment, the blockchain ledger may be accessible through sources 129. Any number of existing blockchain companies or providers may be utilized (Aeternity, Ethereum, Bitcoin, Dfinity, ContentKid, Blockphase, Chain of Things, Flowchain, Decissio, Cognate, SkyHive, Safe, etc.).

The blockchain is utilized as a way to store and communicate the data 126 along with transactions 128. The blockchain may utilized one or more distinct ledgers for different entities, services providers, types of data, users, or so forth. For example, each new user with data received by the data platform 120 is assigned a token or other secure identifier. In one embodiment, the digital tokens may be managed utilizing a key that allows the user or controlling party to access the ledger. In one example, the tokens may be controlled by the user or control may be reassigned. The blockchain may cross-reference updates to the data 126 with the original record for the data platform 120 to ensure proper maintenance, control, licensing, management, and transactions. In one example, different licensing tiers, pricing algorithms, license verification, cause information, and payments are combined to create a unique platform. The illustrative embodiments provide a system 100, cloud system 114, and data platform 120 for compiling businesses that support causes and documenting commercial and consumer transactions that support those causes.

The blockchain may also utilize any number of payment systems (e.g., PayPal, Venmo, Dwolla, Square, wire transfers, credit cards, Quicken, etc.) to fund a tokenized advertising or marketing campaign and to receive money and distribute payments to the applicable party. In one embodiment, the data platform 120 may receive a small fee or percentage per transaction, data uploaded/updated, data purchased, shared, or licensed, purchased item, browsing session, or so forth. In one embodiment, the data platform 120 may be utilized to verify users and advertisers (as well as other users/entities that utilize the data platform 120) and associated data 126 and transactions 128 associated with the data 126.

The third-party resources 130 may represent any number of electronic or other resources that may be accessed to perform the processes herein described. For example, the third-party resources 130 may represent government, private, and charitable servers, databases, websites, services, and so forth for verifying tax deductible or charitable donations of data. In another example, auditors may verify information provided by businesses with regard to the causes 128 associated with the businesses themselves or their associated data 126.

Many segments of the global economy are data rich and include the business operations and individuals involved in the fields of retail, business, agriculture, non-profit and for profit organizations, healthcare, media, government, and finance that all create data that may be captured, tokenized, and monetized by various embodiments as described herein.

In one embodiment the sources 129 may represent alumni, specialty clubs, and affinity groups or organizations that may participate to share or curate their data including user data and profiles. For example, the data may pertain to segmented groups with shared interests or activities that may be monetized. The usage of donations and the delivery of data valuations may be utilized for tax reductions. Various data and venue owners that access the data platform 120 may legally extract and tokenize the data 128 for use in the exchange provided by the system 100 by identifying and tracking data utilizing automatic data extraction tools.

In one embodiment, a user or commercial and consumer group represented by a user of the devices 101 or the sources 129 may elect and receive permission to collect observational data collected from secure and authorized systems to achieve access to partial or complete data from the sources 129 (e.g., professional drivers, human resources, prison records, property values, real estate sales, retail sales, retail prices, commerce, waste stream data, etc.).

The logic engine 122 may perform valuation of the data 126. For example, all the of the global resources and information, such as the price paid for data of all types and transactional data (e.g., micro transactions, cost per thousand, bulk sales, etc.) may be utilized to perform valuations. The logic engine 122 may also track and value accrual, sales, or transfers of data 126 between one or more companies to provide valuations as included in corporate transactions (e.g., acquisitions, mergers, stock purchases, buyouts, etc.). Companies, entities, or other organizations may also value their commercial and consumer data 126 and tie that value to their market capitalization providing public companies the ability to measure and place a valuation on corporate data reserves.

The logic engine 122 may process data feeds received to capture data 126 from companies that the value of commercial and consumer advertisements within the operations of Internet/data, television, radio, print, outdoor, and other advertising for automatic valuations. For example, the logic engine 122 may access sources 128 including data exchanges, markets, consultants, management systems, and so forth to determine the value of the data. For example, current and historical values for data may be determined and utilized in real-time. The data may be valued in a secondary data valuation and futures market exchange or the data platform 120 itself may be utilized in a platform-based valuation index and data exchange, similar to stock exchanges, except for the guided by global price guidelines, rules, and laws for the data industry. The data platform 120 may also make determinations of data utilization and valuation in the dark web to mitigate problems and provide additional potential for platform-based sales and services. In one embodiment, anonymous sources within an opt in system may be utilized to map data values and specific data requests posted and exchanged in the dark web along with the associated value to determine flow and monetization for minimizing potential risks.

The illustrative embodiments may also support third-party valuations of data. The validations may be performed by auditing groups, commissions, industry groups, or other professionals/entities. In one embodiment, the sources 129 may determine or verify data valuations. The data that is improved and/or validated may increase in value. Any number of artificial intelligence or computerized processes may be utilized to validate data. The sources 129 may also aggregate data 126 into portfolios. Portfolios of data may be managed, transferred, and otherwise utilized for the benefit of the data owners.

Data valuation may also be associated with geographic locations. The association of data with a location may be performed utilizing GPS data, location-based services, beacons, wireless triangulation, location-based services, tracking programs, interfaces, connections, protocols, video surveillance, or so forth. For example, by looking at the service locations, layouts, planograms, foot traffic of the venue and interpreting a data capture capability may help determine whether resources are justified or not.

The data platform 120 may provide any owner of data 126 an effective way to value the data. By automatically identifying the drivers of global data transaction valuations, the different stockpiles or silos of data ownership may be understood along with their corresponding value utilizing the data platform 120. The data 126 including groups of data may be utilized to perform fundraising, crowdfunding, or charitable work for a user or group. For example, a school fundraiser may allow people to donate their data 126 temporarily or indefinitely. In another example, an advertiser of a product line may partner with a fundraising group to provide marketing groups that participate in surveys or studies to like-minded commercial and consumer groups, mine data-based insights, such as demographic, political, family, business network, social network, religion, tastes, opinions, past and planned purchases, and other types of marketing-based questions. The donations or incentives may be determined by the size of the group who participate or based on other advertiser and profile ownership parameters.

In one embodiment, the logic engine 122 may utilize artificial intelligence. The artificial intelligence may be utilized to enhance data 126 and increase its value. For example, artificial intelligence may be utilized to review, authenticate, and validate data that is received by the system 100. The artificial intelligence of the logic engine 122 may be utilized to ensure that the data 126 is improved, accurately analyzed, and value increased. For example, it is expected that data and the associated tokens that are validated utilizing artificial intelligence may be given a premium value by both buyers and sellers.

The data 126 may also represent tracking of both real property or intellectual property that may be assigned, managed, licensed, litigated, gifted, transferred, and so forth. For example, the data 126 may be transferred by wills, trusts, end-of-life conveyances, inheritances, liquidations, distributions, last wishes, designated beneficiaries, charitable donations, and other mechanisms used for real and intellectual property. Valuation of a “data estate” may also be performed by the data platform 120 as one of many potential valuations performed as part of the transactions 128. As a result, the data is treated like any number of valuable assets.

In another embodiment, the devices 101 may include any number of sensors, appliances, and devices that utilize real time measurements and data collection to update the data 126. For example, a sensor network, wearables (e.g., watches, bands, implantable devices, etc.) and Internet of things (IOT) devices may gather user and behavioral data. The data platform 120 may also work in conjunction with hands-free data mining and measurement tools that tracks location, activity, and video-based marketing data (e.g., from GPS location, video from storefronts, beacon detection, proximity alerts, etc.) from any number of third-party sources. The user may be tracked through any number of environments, locations, and conditions. Beacons may be used for anonymous and specific data markers and commands. For example, a beacon may be utilized to generate a commercial and consumer interaction in which the commercial and consumer is asked to connect via social media to followers for the purpose of sharing and creating data 126 regarding a specified product or service.

The illustrative embodiments may allow data management to be outsourced from any number of users, businesses, or organizations to the system 100 and/or the data platform 120. For example, the data platform 120 may manage bulk data for a small business without the resources to fully analyze and monetize the data 126. The data 126 and the associated tokens may also be leveraged in times of crisis to obtain loans, provide donations, or otherwise benefit the users.

In one embodiment, the data platform 120 may extract data from third-party platforms by opting in and providing user credentials to various applications (e.g., Facebook, Twitter, Reddit, News Sites, Amazon, Google, etc.) the data platform 120 may extract data from the sources 129.

The data platform 120 may capture known data, behavioral information, psychological, mood data, and other intangible data. The data 126 may be validated through artificial intelligence, machine learning, human analysts/consultants, or other automated or manual processes. For example, the system may be utilized to document participation and track results and side effects from a medical trial. The effective use of the data 126 may be rated for individuals, companies, facilities, or others. Data waste and data proficiencies may be managed through the data platform 120. For example, the data platform 120 may be utilized to determine counterfeits of products, brands through unique product mark documentation and identification via the blockchain.

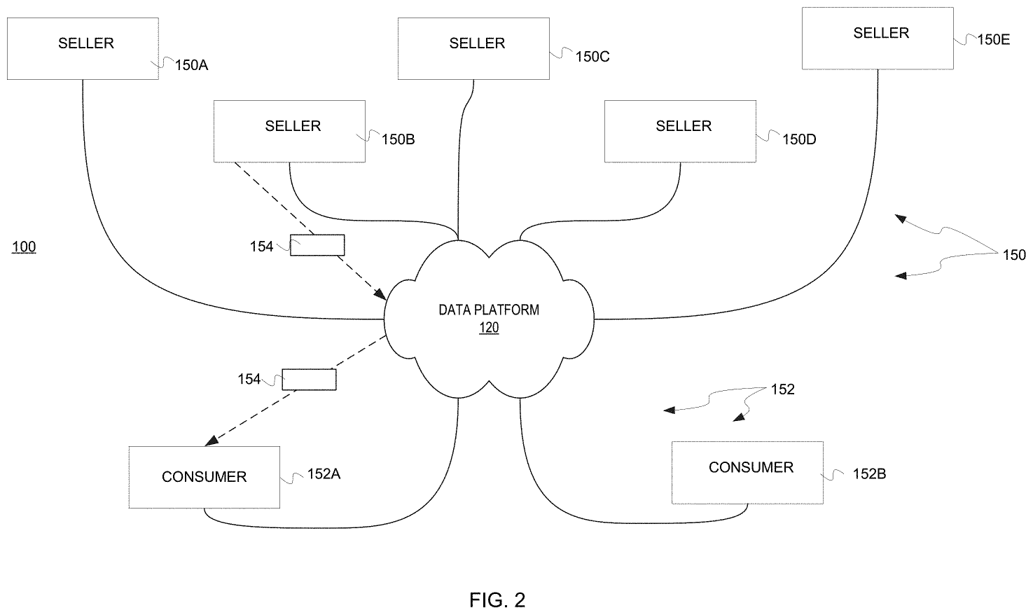

FIG. 2 further illustrates portions of the system 100 of FIG. 1 in accordance with an illustrative embodiment. As shown the sellers 150A-E (jointly sellers 150) may represent the sources 129 of FIG. 1. The sellers 150 may represent any number of fund managers, monitoring groups (e.g., diversity, equity, inclusion, LGBTQ+, etc.), advertisers, marketers, businesses, retailers, service providers, individuals, organizations, entities, or so forth referred to as sellers 150 or businesses for purposes of simplicity. The commercial and consumers 152A, 152B (jointly commercial and consumers 152) represent any number of users, commercial and consumers, groups, or individuals that have data 154 that they are willing to allow the sellers 150 to access through the data platform 120. In one embodiment, the data platform 120 may represent all or portions of the system 100 of FIG. 1 (including the cloud system 114, servers 116, databases 118, etc.).

The consumers 152 may actively or passively incentivized or prompted to upload data 154 to the data platform 120. The data platform 120 may also receive amended, updated, or additional data 154 for the consumers 152 at any time as described herein. The consumers 152 may have an agreement for the distribution of the data 154 to the sellers 150 or other interest parties. The agreement or contract may specify how, when, and what portions of the data 154 may be used as well as the associated compensation terms. The agreement may specify that the data 154 may be purchased, licensed, rented, leased, or otherwise managed by the data platform 120 for the mutual benefit of the consumers 152 and the sellers 150. For example, the consumer 152A may elect to receive a one-time payment of tokens for data 154 provided to the data platform 120 for seller 150A. In another example, the consumer 152B may elect to license use of their data 154 such that they are compensated utilizing a digital currency (or hard currency) for each access of or utilization of their data 154 by the sellers 150.

The data platform 120 performs valuation of the data 154 based on information from any number of sources including current rates, contracts, indices, exchanges, and other applicable information. For example, current targeted advertisement rates may be utilized to value the data. The tokens paid to the consumers 152 in exchange for the data 154 may vary based on the volume, quantity, verification, and types of information included in the data 154. The data platform 120 normalizes data monetization for the consumers 152 and sellers 150. Compensation performed by the data platform 120 may be performed utilizing known cryptocurrency and may fund the tokenization through traditional funding utilizing digital currencies or existing currencies. In one embodiment, blockchain-based currencies may be utilized to compensate the consumers 152. Full tokens or partial tokens may be utilized to most accurately represent the values being exchanged. There may be a predefined number of tokens available thereby allowing early adopters of the system 100 to earn more over time. For example, in response to the consumer 152A selling the data 154 to the data platform 120 or the seller 150B, the consumer or commercial user may be compensated with tokens (e.g., Bitcoin, Ethereum, proprietary tokens, etc.). All or portions of the data 154 may be involved in a transaction. For example, the data 154 may include numerous components relating to all aspects of the life, work, hobbies, entertainment, studies, politics, health, family, commercial and consumer habits, for the consumer 152B. The seller 150D may only license rights to temporarily (e.g., for one year) access the commercial and consumer habits of the consumer 152B existing and updated in real-time. The exchange for the tokens may include a pointer to a secure storage or vault accessed through the data platform 120. The pointer may be an encryption key, access information, unique identifier, or other security information for accessing the data 154 associated with the user. In another embodiment, security tokens used for the blockchain may also be embedded with the data 154. The tokens granted through the data platform 120 may vary in value, may be fixed, or may act similar to other monetary instruments (e.g., stocks, bonds, certificates of deposit, etc.) for a specified original value of the data 154.

The data platform 120, sellers 150, or consumers 152 may keep and maintain digital ledgers that track the transactions within the system 100 to verify and authenticate the data and associated transactions. The sellers 150 may utilize the data 154 to advertise, sell, or market goods, services, products, perform market research, generate analytics, or so forth. As previously noted, the data platform 120 may also represent one or more processing, analysis, blockchain, or distribution centers, systems, devices, facilities, or so forth. The sellers 150 and consumers 152 may represent any number of individuals or groups (e.g., hundreds, thousands, millions, etc.).

As noted, the sellers 150 may send or distribute goods and services 154 through the cloud system or directly to the consumers 152. In one embodiment, the seller 150B may distribute goods and services 154 to the consumer 152A through the data platform 120. The data platform 120 may perform distribution of the goods and services 154. For example, the data platform 120 may include any number of physical storages, digital storage, warehousing, and distribution systems, facilities, professionals, employees, contractors, electronics, and so forth.

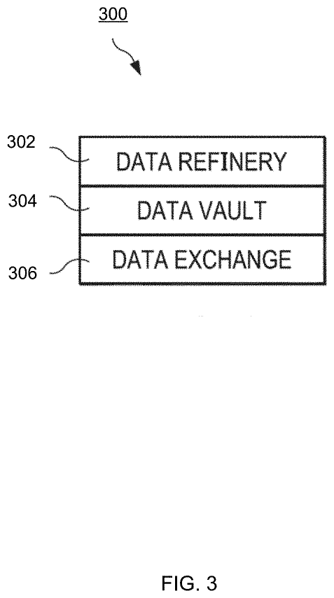

FIG. 3 is a pictorial representation of a platform 300 for monetizing data in accordance with an illustrative embodiment. The platform 300 may include a data refinery 302, a data vault 304, and a data exchange 306. The platform 300 of FIG. 3 may be representative of one or more devices, such as the servers 116, data platform of FIG. 1, or other smart networked device implementing specific hardware, software, firmware, and/or sets of instructions. The platform 300 including the data refinery 302, data vault 304, and the data exchange 306 may function as separate platforms or an integrated platform.

The data refinery 302 is utilized to create data objects and capture applicable data to include the data objects. In one embodiment, the data refinery 302 may be positioned within the user's existing system to capture data that is already received, entered, gleaned, or otherwise determined by the existing system. The data object may be created to store all, portions, or types of data associated with the user (e.g., individual, couple, family, company, organization, group, entity, etc.).

The data vault 304 is utilized to securely store the data objects and add, modify, and improve the associated data. In one embodiment, the data vault may be utilized to collect, characterize, and value the data. The data vault 304 may also determine the pace at which new data objects ae added or updated as well as the types of data. For example, the data vault 304 may determine that information relevant to two of the user's clients including company practices for recruiting and hiring diverse executives, employees, and vendors that are added to the data vault 304 each day. The data vault 304 may be a physical or virtual storage and vault that securely stores information. In one embodiment, the data objects may be deidentified to remove identifying information to prevent hacking, identity theft, and other unwanted or prohibited utilization of data. The data vault 304 may also assign an initial value for the data object. The value may be associated with similar data, going rates, completeness of the data, the type of data, the user supplying the data, historical information, and so forth. The value may change at any time based on a determination of the platform 304 (i.e., the data vault or data exchange).

The data exchange 306 is utilized to price and perform transactions for the data objects. In one embodiment, the data exchange 306 creates a ticker associated with the data object. The ticker may be associated with the data object(s) for a user. The data exchange 306 allows the data objects to be priced and purchased. In one embodiment, exchange may utilize secure tokens to access the data. For example, transactions involving the data may represent a key for accessing the purchased or leased data. For example, the tokens may include an encryption key, password, biometric, or other secure identifier for accessing the data object from the data vault or other stored location. The data exchange 306 may utilize non-fungible tokens (NFT) to perform one or more transactions. NFTs are tracked on blockchains to provide the owner with a proof of ownership that is separate from copyright.

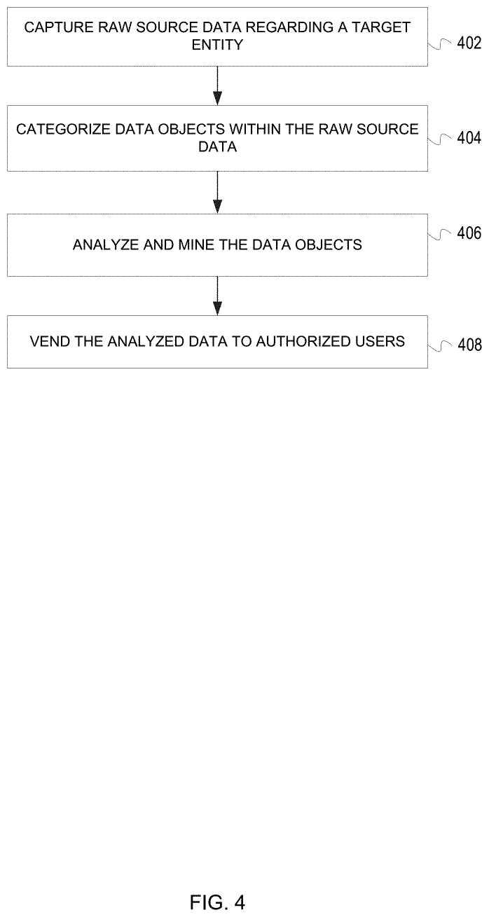

FIG. 4 is a flowchart of a process for analyzing data in accordance with an illustrative embodiment. The process of FIGS. 4-6 may be performed by a platform, device, server, or other equipment in accordance with illustrative embodiments. All or portions of the process of FIGS. 3-6—may be performed automatically. The process of FIG. 3 may be implemented by a system or platform, such as the system 100, data platform 120, or devices 101 of FIG. 1 referred to generically herein as the platform. The steps of FIGS. 4-7 may be combined and utilized in any order.

The process may begin by capturing raw source data regarding a target entity (step 402). The raw data may be captured from any number of sources. In one embodiment, the platform may access public and/or private information and databases. For example, the sources may be available from the target entity, company, group, organization, or individual(s). Company resources may be accessed for capturing the applicable data from servers, databases, profiles, webpages/intranets, networks, employees, and so forth. Other public or private information may also be captured, gathered, or retrieved from any number of sources. For example, subscription services may be utilized to retrieve applicable information.

Next, the platform categorizes data objects within the raw source data (step 404). The platform may compile and categorize the data objects and data sets associated with the target company, entity, users, or so forth. As noted, the data object may include revenue reports, corporate filings, press releases, profiles, user selections, company/user input, sensory data, or other information and data actively or passively gathered about the target company as objects attributes, elements, fields, sets, pools, or other configurations of data. The profiles may be applicable to websites, mobile applications/programs, services, devices (e.g., smart phones, vehicles, smart furniture, etc.), logistics, or so forth. The data may be acquired over time based on the input, selections, activity, and other actions of the target entity. The data object may also be acquired in real-time. The data object may include any number of categories, fields, or values that may be expanded over time to capture relevant information about the target company in any number of fields, categories (e.g., diversity, ethics, positions, politics, etc.), experiences and so forth. The data may include public, private, customized, and proprietary data available to the platform. In one embodiment, the raw source data and the analyzed data are stored. For example, the raw data may be stored in a repository, such as a cloud database.

Next, the platform analyzes and mines the data objects (step 406). The platform may analyze the data objects (and/or raw source data) which may be used to weight and measure various criteria for a company to provide indicators regarding the target entities true employee and leadership diversity within a corporate structure, social programs, and so forth. The analysis may be performed to enhance availability and transparency of applicable information. For example, the data objects may be compared against criteria, parameters, and standards set by any number of industries, groups, goals, and so forth. The data objects, data, and information of the target entity may be mined to make various determinations regarding the target entity or their partners, affiliates, distributors, suppliers, manufacturers, and so forth. For example, the platform may make determinations regarding compliance with the applicable goals and standards as herein referenced.

Next, the platform vends the analyzed data to authorized users (step 408). The authorized users may represent any number of individuals, entities, exchanges, or organizations. In one embodiment, the platform may sell subscriptions to a service to view the analyzed data. The analyzed data may also be purchased as profiles regarding one or more target entities that are tracked and analyzed by the platform to enhance various social causes.

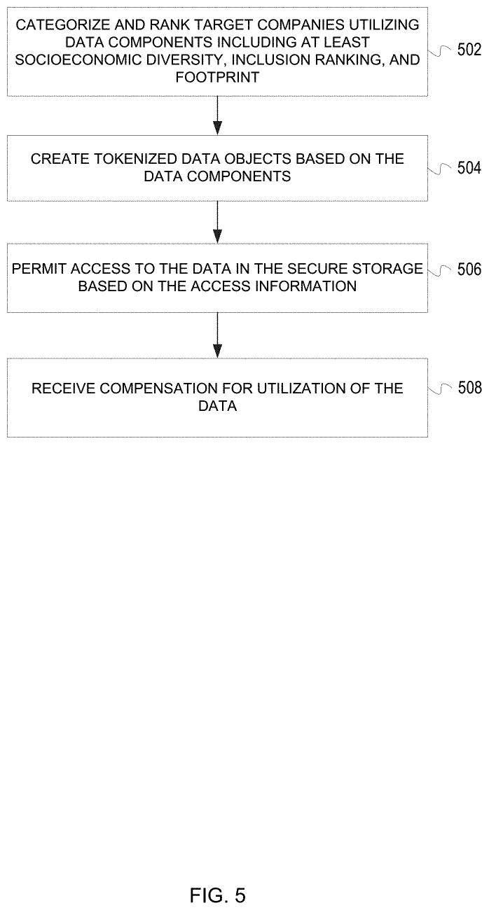

FIG. 5 is a flowchart of a process for managing data utilization in accordance with an illustrative embodiment. The process may begin by categorizing and ranking target companies utilizing data components including at least socioeconomic diversity, inclusion ranking, and footprint (step 502). The platform may utilize any number of data, values, parameters, criteria, and factors for categorizing and ranking the various target companies. The application data may be compared against any number of standards before or after processing. Raw data or processed and weighted data may be utilized to perform categorization and ranking. For example, company information and data regarding all levels of employees, executives, contractors, and others associated with the company may be utilized to provide information about diversity at the target companies. In another example, operation, manufacturing, retail, office space, shipping, and other operations of the target companies may be utilized to determine the carbon footprint, sustainability, waste management, energy utilization/preservation, and so forth. Similar examples, are applicable to internal labor standards, good governance, human rights, internal company rankings, legal compliance, equality and inclusion,

Next, the platform creates tokenized data objects based on the data components (step 504). In one embodiment, the data objects may be stored in a security token. For example, the security token may be generated utilizing blockchain. The tokenized data object may include all or portions of the data object associated with the target company. For example, one security token may incorporate information relating to the strategy, goals, and operation of the target company. In one embodiment, the tokenized data objects in a security token are a form of digital currency that may be spent, exchanged, granted, transferred, or utilized for any number of purposes.

Next, the platform permits access to the data in the secure storage based on the access information (step 506). In one embodiment, the platform may grant access to authorized users, devices, entities, organizations, or so forth. The platform may grant access utilizing any number of preferences and settings. Access to the data may be granted utilizing passwords, encryption, tunnels, software interfaces, hardware interfaces, or other standards, protocols, hardware/software, schemes, or processes. The platform may also utilize other processes for securely storing and accessing any of the data, tokens, objects, and information described herein.

Next, the platform receives compensation for utilization of the data (step 508). The compensation may be paid to the platform service provider, the user associated with the data, or any number of other parties. For example, users may be compensated for providing access to their data. In one embodiment, the platform may provide access through a subscription service. The subscription may be utilized to research any number of target companies. The platform may charge authorized users per search, report, time researching, per target company, or other metric or process. The data and information may be utilized to ensure the target companies support equality and diversity efforts.

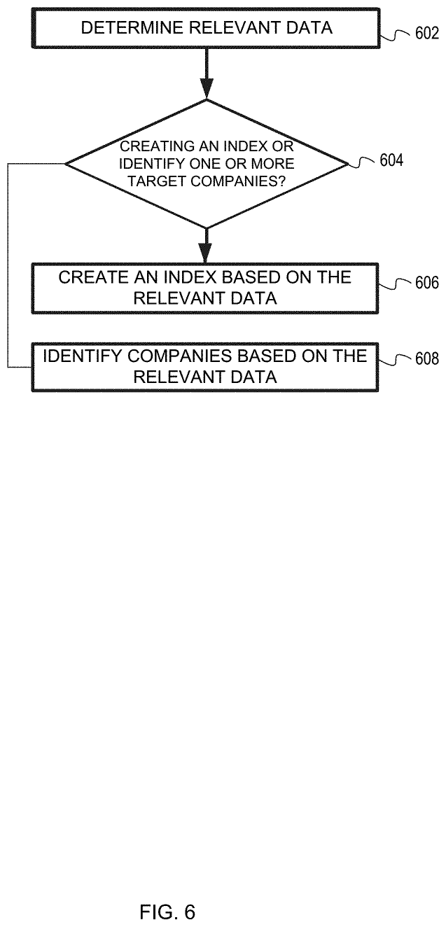

FIG. 6 is a flowchart of a process for scoring data in accordance with an illustrative embodiment. The process of FIG. 6 may begin by determining relevant data (step 602). The relevant data may relate to one or more target companies. The relevant data may include data, information, and vectors related to the economic growth, corporate changes, social understanding, diversity, and other information determined in real-time or over specified time periods.

Next, the platform determines whether to create an index or identify one or more target companies (step 604). A user, device, entity, or party accessing the platform may determine the types of information required.

If the platform determines to create an index, the platform creates an index based on the relevant data (step 606). Any number of companies or other entities may be grouped, tracked, or measured utilizing numerous criteria, data, and information as detailed herein. The relevant data may include empirical data that is scientifically gathered or derived. In one embodiment, the index may include any number of target companies that support diversity, equality, and other causes. The index may represent one of numerous potential indices that may group target companies. The human data may be utilized to track opinions, thoughts, and trends for individuals, groups, entities, and others.

In one embodiment, the index may include target companies that are selected based on weighting and selection by a number of parties. The “crowd” may include experts or individuals with significant life, professional, or social experience and knowledge. At any point individual feedback may be utilized to receive user input, information, details, factors, criteria, weighting information, rating information, parameters, and other data.

If the platform determines to identify on or more target companies, the platform identifies companies based on the relevant data (step 608). The relevant data may be utilized to identify companies that have a particular profile, operational standing, or other information. For example, the platform may provide or refer partner services for enhancing hiring and managing skills of a diverse set of executives and employees to advance diverse communities and workforces. Any number of partnerships, affiliations, referral, influencers, or other products and services may be implemented by the service provider of the platform.

In one embodiment, the identified companies may be utilized to perform one or more actions, such as inclusion in an index, ETF, or fund, performing a transaction (e.g., buy, sell, limit, market, etc.), send an alert/notification, or so forth. In one embodiment, the target companies may be provided information regarding equality, diversity, and inclusion that may be privately or publicly available. The target company may purchase or hire the platform service provider for consulting services, a full report, suggested changes, an executive action plan for improvement, or other products and/or services that may be to their benefit.

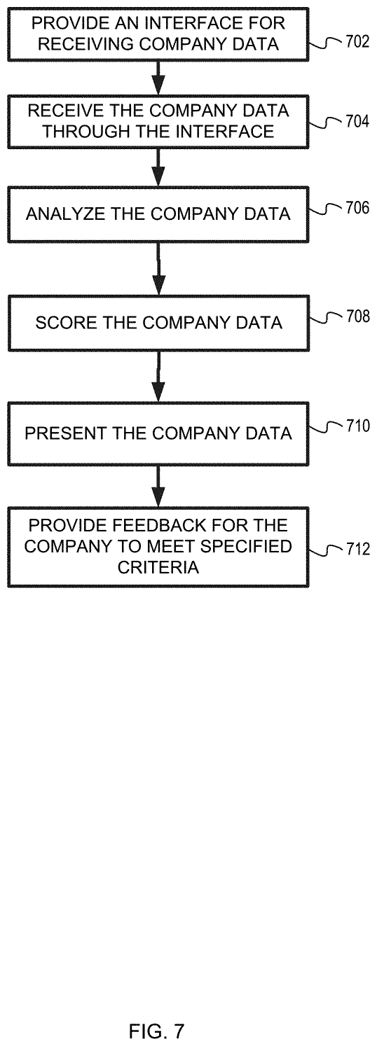

FIG. 7 is a flowchart of a process for providing data about a company in accordance with an illustrative embodiment. The process of FIG. 7 may begin by providing an interface for receiving company data (step 702). In one embodiment, the interface may be a proprietary interface that uniquely and efficiently receives (and presents) information and data from one or more users, clients, companies, entities, organizations, or so forth. The interface may include one or more application program interfaces (APIs) for receiving data from any number of programs, applications, or so forth. The interface may interact with any number of other systems, platforms, software, or other devices to receive the company data for further processing, analysis, scoring, and presentation.

Next, the system receives the company data through the interface (step 704). Users may directly or indirectly interact with the interface. In one embodiment, the interface may present any number of polls, surveys, questions, and other requests. The company data may include objective, subjective (e.g., opinions, feelings, etc.), personal, and other data that is associated with the company. For example, the company data may include objective measures, such as stock price per data, revenue, debt, as well as subjective data, such as the opinions of individual users regarding the company. Polling of minority or target data may be prioritized to obtain an important viewpoint. The company data may be filtered through any number of filters to obtain relevant and focused results. The annual poll data used by the illustrative embodiments may be utilized to increase the understanding of multiple social minorities and reflects the voice of the crowd needed to impact the change of the majority. For example, the changes may provide direction for social and corporate changes for the growth of minorities across the spectrum of equality and social governance. The surveys provide significant amounts of data from minorities and others that go beyond the index value and constituents. In one example, individual users may be requested to give their comments on a small grouping of companies within the social universe of companies. The received information may be utilized to include and amplify the voice of the crowd including employees, executives, and stakeholders equally.

Next, the system analyzes the company data (step 706). The company data may be analyzed and processed to determine the direction of multiple vectors, such as economic growth, corporate changes, social understanding, and so forth. The analysis and analytics of step 706 may be utilized to measure current and future drivers needed to support corporate and social change. Any number of programs, algorithms, scripts, or processes that are automated or require user input may be performed to analyze the company data. The final index may give DEQI scores to the poll responses.

Next, the system scores the company data (step 708). Any number of scoring and ranking systems may be utilized by the system. For example, minority or female empowerment scores may be utilized. For example, ESG and DEQI scores and ranks may be generated. The scores may be utilized to show diversity and empowerment of various different groups. The scoring may provide equality, diversity, and inclusion information for utilization as a key business concern.

Next, the system presents the company data (step 710). The company data may be presented utilizing a proprietary user interface, mobile application, program, website, and/or other interfaces. The company data may be presented visually, audibly, tactilely, or using any number of other formats. Utilization of the company data through investor and trading data may be utilized to capture index adoption and uses. The company data may be utilized to ensure equality (e.g., compensation, benefits, etc.), attention, and treatment are fair for board members, executives, employees, staff, vendors, consultants, contractors, and others associated with the company.

Next, the system provides feedback for the company to meet specified criteria (step 712). The feedback may include input, instructions, or suggestions for a company to meets specific criteria that enhances diversity and social goals. The companies that have low scores or are excluded from an index or other initiative may receive additional consulting, education initiatives, or feedback (i.e., feedback regarding company hiring, practices, and processes regarding race, ethnicity, gender, age, sexual identity, employee experience, etc.). In one example, the advancing black equality (ABE) index is a multi-cap index of public companies that support change in the black and brown minorities.

In one embodiment, the scores may be utilized to populate and rank companies within a rating system associated with DEQI. For example, companies that are at the 25% of the companies or below a specified level may be red flagged and notified of the potential for removal from consideration. The companies may be given notifications so that adjustments to their business or processes may be implemented.

Various decisions may be implemented to monetize company data. The company data may be monetized for an aggregator, service provider (e.g., platform manager), investment group, a charity or cause, or other individual or group. In one embodiment, a company profile associated with the platform may specify the types of data that may be captured directly from the company through non-public sources as well as how the data object(s) may be utilized. For example, a platform profile may include any number of settings, configurations, parameters, selections, releases, authorizations, verification requirements, or other information and data that controls how the company's data is utilized in accordance with the illustrative embodiments. The company data may be monetized through sale, license, royalty, rent, lease, exchange, pay-per-use, and other forms of commercialization. Any number of security tokens, digital currencies, non-fungible tokens, or real currencies may be used in whole or partial values.

Any number of processes may be utilized for managing utilization and compensation for the company data. In addition, to indices and other publicly available investment projects the company data may also be discretely used. The company data may be received, aggregated, analyzed, processed, and stored in a secure storage. The secure storage may represent a vault, archive, secured server farm, or other secure mechanisms or locations. The secure storage may represent a secure server that is integrated with the user's network, system, architecture, platforms, or so forth. Access information may be utilized to access the company data. The system or platform may permit access to the information is response to receiving access information from the managing party. The company data may be communicated utilizing any number of secured channels, networks, tunnels, or so forth. In one embodiment, applications executed by the data platform and a device of the accessing party may be utilized to securely exchange data. Compensation for utilization of the company data may received in any number of formats, payment methodologies, time frames, and so forth. The compensation may represent any number of digital currencies (e.g., tokens), real currencies, rewards, exchanges, and so forth.

The illustrative embodiments may be utilized to perform transactions of the company data in real-time, based on historical trends, or based on forward or futures contracts. The illustrative embodiments provide a system and method for data valuation, data management, and data governance for corporations, organizations, individuals, and data vendors to convert company data into an asset that enhances diversity and inclusion for both companies and individuals while providing measurable and quantifiable revenue.

The illustrative embodiments allow for the creation of a data derivatives indices, markets, products, and contracts based on company data for diversity and inclusion. The creation of a data valuation marketplace for diversity and inclusion information may also allow companies to provide audits of data balance sheets and other data specific statements, much like traditional financial statement audits. The illustrative embodiments provide a system, method, and platform for providing historical prices and a data exchange for trading and otherwise transacting associated company data. It is often understood that there are five known and understood core asset classes in addition to sub asset classes. The common asset classes may include shares/equities, bonds/fixed-interest stocks, property, commodities, and cash. Previously, data assets, such as corporate data, would be classified as an intangible asset that falls under the “property” asset class with several additional intangible asset valuation methodologies used to determine the true value of a data sort as an asset. Any number of data valuation principles may be utilized in allowing company data to be viewed, valued, and utilized as an asset class.

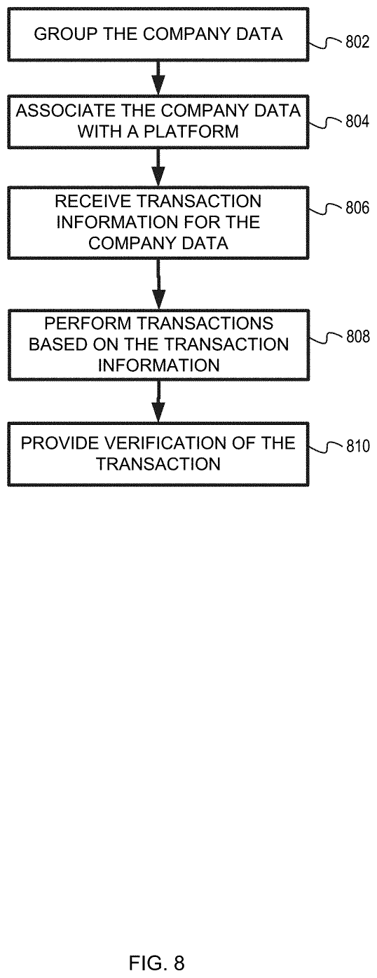

FIG. 8 is a flowchart of a process for grouping data in accordance with an illustrative embodiment. Any number of transactions may be performed utilizing one or more portions of the system 100 (e.g., cloud system 114, data platform 120, etc.) of FIG. 1 and the associated company data. The process may begin by grouping the company data (step 802). As noted, the company data may have been previously received, aggregated, analyzed/processed, or otherwise evaluated. In one embodiment, the company may be grouped as part of an index. The company data may also be referred to as a data asset or data token. The company data may be grouped based on market capitalization, DEQI score/ranking, technology/business sector, business/entity/organization, company profiles, affiliations, self-selections, or one or more criteria, parameters, profile elements, data points, or other applicable data and/or information. The company data may be stored in one or more servers, databases, or systems. In one embodiment, the company data may be grouped utilizing pointers, calls, addresses, identifiers, or other information as units, sets, collections, or so forth. For example, specialized hardware may store data associated with each user to ensure privacy and protection of the company. The hardware may be partitioned, protected, or otherwise secured.

Next, the system associates the company data with a platform (step 804). The platform may be a platform authorized to perform data transactions. In some embodiments, multiple platforms may exist for simultaneous, concurrent, or sequential transactions that involve the data. In one embodiment, the platform may be part of the system. For example, the platform may be a data platform/trading platform for performing different types of transactions (e.g., sales, purchases, receipts, payments, etc.). Any number of market, limit, short, put, option, future, or other transactions may be utilized for the company data. In addition, the platform may manage which companies are included in indices, funds, and/or other information or investment products and services.

Next, the system receives transaction information for the company data (step 806). The transaction information may specify an index, fund, investment product, or other details for performing a transaction associated with one or more governments. The transaction information may include the type and amount of data that is included in the transaction. The transaction information may also specify the price or compensation associated with the transaction (e.g., dollars, bitcoins, exchanged goods, trading information, etc.). The transaction information may also provide details including, but not limited to, the predetermined price (forward price), the delivery date when delivery and payment occur, the buyer (i.e., long position holder), the seller (i.e., short position holder), margin information, third parties involved, and so forth. In one embodiment, the transaction information may include fields or data that is automatically provided or entered by one or more users. Other trading platforms, devices, or equipment may communicate with the system of FIG. 8.

Next, the system performs transactions based on the transaction information (step 808). The transaction is performed based on the transaction information provided during step 806. As noted, the transaction information may be determined automatically, based on specified user input, or based on a combination of automatically determined/generated information and manual information. The transaction information of step 806 may include user input specifying how, when, why, and where the transaction is to be implemented.

Next, the system provides verification of the transaction (step 810). The verification may include all of the details for the transaction as previously noted. The verification may be sent as an email, printed receipt, invoice, in-application message, text message, chat message, or other form of digital or physical message. The transaction may uniquely identify the transaction with one or more codes, digital fingerprints, or identifiers. The transaction verification may be utilized for tax purposes, business tracking/ledgers, profit/loss analysis, and any number of purposes. The transaction may also verify that a persona, group, or entity is supporting companies with specified diversity, equality, and inclusion profiles.

The illustrative embodiments may capture company data from any number of online, digital, physical, and other data collection sources to generate a broad range of internal and external commercial and consumer insights. In one embodiment, the data collections true value may be measured by data source, source reliability, data volume, data reliability, data coverage, data functionality/multi-functionality, and end results. Company data sources may be identified, located, and evaluated for cost, coverage, and quality. The system may apply any number of mathematical processes, interpolation, modeling, optimization, machine learning, image analysis, and statistical methods to the company data to perform assimilation and analysis. The data determinations performed by the systems and methods herein described may include performing data integration and categorization. Additional determinations may be made to key data points within the data structure to indicate whether the data point is considered influx or perennial data.

The system may also reconcile the company data. In one embodiment, the company data may be integrated into an index, ETF, fund, and/or data marketplace managed by the system, analyzed, categorized, and valued for immediate actionable insights by identifying influx data with the limited data value window (e.g., advertising conversion).

Next, the system performs current and future data valuations. The platform-based data marketplace supported by the system may evaluate the data based on the reusability of each unique data point in a data pool. The reusability of the data may be a key indicator for measuring the size and scope of additional data utilization. Valuations may be performed based on real-time prices for data or similar data utilizing any number of parameters, conditions, factors, information, settings, providers, and so forth.

The company data may be monetized in any number of ways. For example, data object may be created in a data refinery. The data objects may be associated with particular companies and may include many distinct categories and types of data associated with one or more time periods (e.g., diversity, equality, inclusion, etc.). The data refinery may be physically or virtually integrated with the user's systems. For example, one or more networks and cloud devices and systems may be utilized. The platform collects company data for the data object from the one or more companies in a data vault. The company data is collected and added to the data object. In some instances, new data may replace or modify old data to ensure that the data objects are up to date. In one example, the data object is a company profile.

The platform characterizes and values the company data object in the data vault. The platform may determine when, how, and what types of company data are received to characterize the company data as well as the pace of received company data. The platform may also value the company data received. The value may represent a fixed and/or starting/initial value for the data object.

The platform lists the data objects on an index, fund, or exchange for secured transactions. The platform may utilize a ticker, such as GCO.1w or DDT.TCH1, to designate the user or type of data. The ticker may be utilized to perform any number of real-time, market, limit, short, option, or other transactions. Tokens traded may utilized the ticker to identify the data and access the data. For example, the tokens may include keys or indicators for accessing the data object. The exchange may represent an open exchange open to any number of lawful parties that are registered or otherwise authorized to perform transactions. The data assets may be tokenized and converted into named trading assets of a data source provider. The objectified data assets may allow of the direct control, valuation, and monetization of the company data. Monetization may be performed through a process that is achieved through data refinement, objectification, virtual reality tokenization, valuation, ticker assignment, and open transactions. Trades on the exchange may be executed privately or publicly utilizing digital currencies, hard currencies, charitable contributions, trades, and credits.

Global equality occurs when companies, individuals, institutions, governments, and others provide equality opportunities to people from all backgrounds. Gender equality promotes equal power and access to opportunities for women. LGBTQ+ equality promotes equal opportunities respective of sexual orientation and gender identity. The illustrative embodiments provide individuals, groups, communities, entities, corporations, and others equal empowerment and opportunities of all types irrespective of gender, race, ethnicity, sexual identity, disabilities, and other factors. Improving, empowering, and advancing racial, gender, ethnical, LGBTQ+, and disability equality improves the quality of life for women, men, families, communities, and society as a whole by allowing individuals to thrive as citizens, innovators, job creators, employees, investors, and contributors.

The illustrative embodiments utilize a symbiotic relationship with the crowd that enables the various systems and methods to harness the power of people to effect maximum return on social impact (ROSI). The illustrative embodiments may monetize the platform, systems, and company data through any number of license indexes, exchange traded product (ETP) sponsorships, proprietary data analytics, consultive programs, and other products and services. For example, the illustrative embodiments may license indexes that will accrue recurring license fees from turnkey asset management platforms (TAMP, simple moving averages, unified managed account, self-indexing, etc.) and global asset managers. In another example, ETP sponsorships may require recurring license fees on shared assets under management (AUM) and minimum annual fees for revenue from listed, over-the-counter markets, ETPs, swaps, equity linked notes (ELN), and structured product solutions. In another example, the illustrative embodiments may provide proprietary data analytics for investors and quantitative sales as a license fee (e.g., daily, weekly, monthly, yearly, etc.), per request/search/usage, or other fee. In another example, consulting services and programs may be utilized by clients aligned with various diversity and inclusion efforts.

In one embodiment, the top companies with DEQI scores may be included within a diversity and inclusion index. The indices may be compiled automatically based on the processed data or based on the processed data and user analysis. The illustrative embodiments may provide predictive analytics, algorithms, and automated trading. In addition, the illustrative embodiments may enable a power ratings system across socio economic groups for equities and debt sectors for companies as their DEQI scores dynamically increase and decrease as naturally happens with all companies.

The illustrative embodiments provide a secure system, method, platform and devices for securing and maximizing the value of company data into a marketable or tradable asset. Data may be collected, updated, aggregated, processed, analyzed, and utilized in real-time market conditions. The company data may be associated with a secure key accessed through a blockchain token to securely monetize the data. In another example, the company data may be incorporated into a non-fungible token. Any number of transactions may be performed utilizing the company data across as implemented by a data exchange including transactions that are performed on exchanges, such as the New York Stock Exchange, Nasdaq, London Stock Exchange, Chicago Board Options, Exchange, and so forth. The platform may automatically match company data with indices, individuals, companies, entities, groups, or organizations who find the data most valuable and are willing to productively pay for a use the data. The transparent and open marketing of the company data encourages diversity and inclusion and new metrics for evaluating companies, indices, investment products, and so forth.

Turning now to providing additional information regarding data valuations, data valuation may be performed at any time for different selections, groups, amalgamations, cohorts, populations, data sets, combinations, and so forth. As previously noted, company data may be generated from countless online, retail, digital, mobile, and service-based data sources. Company data is often already used to support a business, organization, or entity's business model. The illustrative embodiments differentiate and value data in categories related to ongoing data accumulation of variable commercial and consumer data points by determining and measuring when and if certain data points are in a constant state of flux, perennial, or static/non-changing.

The data may be collected from various data collection sources and integrated into a data pool as raw data that may then be categorized, assimilated, processed, and analyzed for marketable and actionable insights. The unique nature of raw data may allow it to have potentially limitless end uses and depending on data reliability and the user intention, the uses cases may vary, change, and adapt over time. The value for the company data in the data pool may be driven for the supply and demand for all or portions of the data pool, data points, and so forth. Completeness of user profiles may also provide added value for the data reliability and inherent value with various data marketplaces.

Several of the key components of data reliability may be broken into data that is anchored into the user profile and non-changing data that is a constant state of data flux. The data flux is inherent in data categories with a limited time window for the data to have maximum value for a specific category. Data flux may be inherent in data categories with a limited time window for the data to have maximum value for a specific category.

Influx data value may be combined with perennial data or anchored data points allowing profile data to gain value overtime as data points are added, updated, and user profiles become completer and more robust. The same constant state of data flux may also allow data profiles or data sources to lose value over time if the data becomes stale, non-targetable, or less relevant to marketers.

The platform may classify and value profile data elements by 1) grouping each data element into distinct categories, and 2) creating repositories that measure the fluctuating value of commercial and consumer data elements when any element of the data points that may be monetized. The company data may be categorized and grouped into data repositories and tracked in real-time through exchanges of targeting data pricing based on known CPC, CPM, and CPA prices. The platform may measure the degree of value and success based on the availability of user profile data points and when and which relevant data elements are used when monetizing the data.

The platform may measure and value each utilization of specific company data and profile elements in the repository and may measure and value large corporate data repositories providing both leading and trailing indicators measure the fluctuating value of that data when used for targeting online advertisements to a device or targeting user for real-world marketing-based advertising, education, social and equality changes, and so forth.

The illustrative embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible or non-transitory medium of expression having computer usable program code embodied in the medium. The described embodiments may be provided as a computer program product, or software, that may include a machine-readable medium having stored thereon instructions, which may be used to program a computing system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object-oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (e.g., through the Internet using an Internet Service Provider).

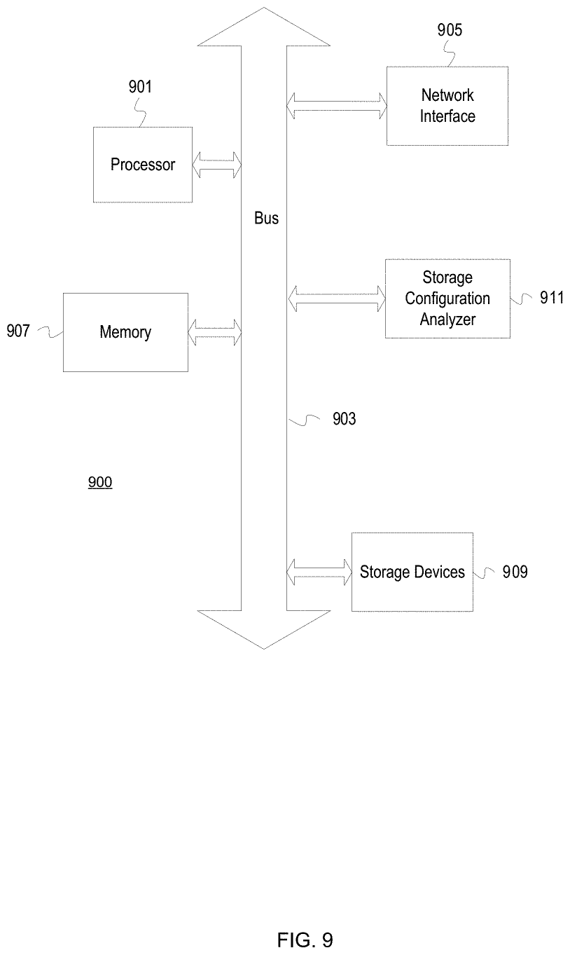

FIG. 9 depicts a computing system 900 in accordance with an illustrative embodiment. For example, the computing system 900 may represent a device, such as one or more of the devices 101 of FIG. 1. The computing system 900 includes a processor unit 901 (possibly including multiple processors, multiple cores, multiple nodes, and/or implementing multi-threading, etc.). The computing system includes memory 907. The memory 907 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computing system also includes a bus 903 (e.g., PCI, ISA, PCI-Express, HyperTransport®, InfiniBand®, NuBus, etc.), a network interface 905 (e.g., an ATM interface, an Ethernet interface, a Frame Relay interface, SONET interface, wireless interface, etc.), and a storage device(s) 909 (e.g., optical storage, magnetic storage, etc.). The system memory 907 embodies functionality to implement embodiments described above. The system memory 907 may include one or more functionalities that store content, blockchain data, parameters, application, user profiles, and so forth. Code may be implemented in any of the other devices of the computing system 900. Any one of these functionalities may be partially (or entirely) implemented in hardware and/or on the processing unit 901. For example, the functionality may be implemented with an application specific integrated circuit, in logic implemented in the processing unit 901, in a co-processor on a peripheral device or card, etc. Further, realizations may include fewer or additional components not illustrated in FIG. 9 (e.g., video cards, audio cards, additional network interfaces, peripheral devices, etc.). The processor unit 901, the storage device(s) 909, and the network interface 905 are coupled to the bus 903. Although illustrated as being coupled to the bus 903, the memory 907 may be coupled to the processor unit 901.

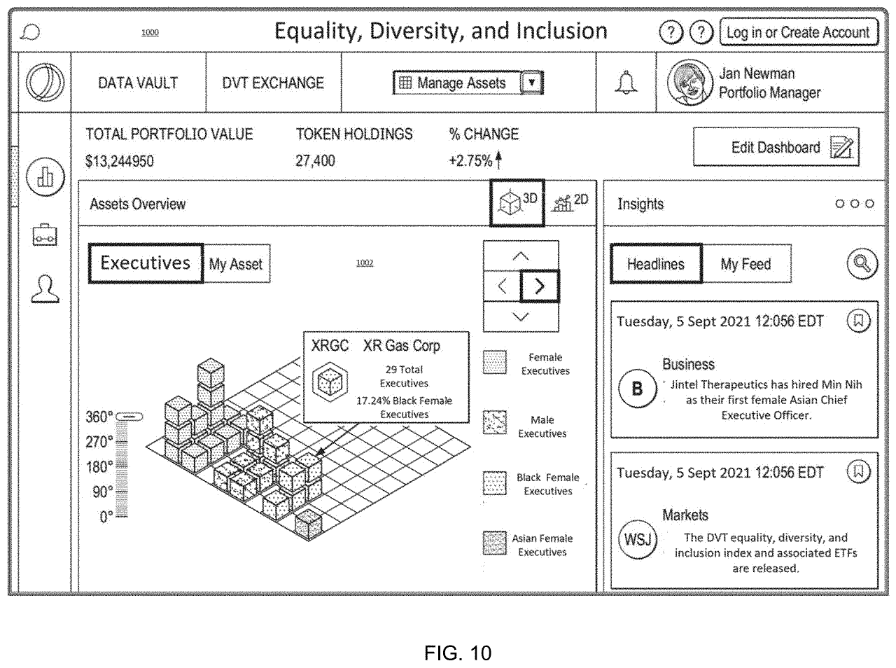

FIG. 10 is a pictorial representation of a user interface 1000 for displaying company information 10002 in accordance with an illustrative embodiment. The user interface 1000 may be displayed by any number of computers, laptops, wireless devices (e.g., smart phones, tablets, etc.), terminals, televisions, or other smart electronic devices. The user interface 1000 may be integrated with an application, program, script, or set of instructions for tracking, analyzing, managing, communicating, and otherwise displaying company information as herein described. The user interface 1000 is one example of numerous interface windows that may be presented to a user through a proprietary interface, program/application (e.g., mobile app, browser, etc.), terminal, or other software/hardware component.

The user interface 1000 may uniquely present information that may be utilized to automatically or manually perform any number of processes. The user interface 1000 may present any number of views, windows, tabs, icons, graphics, tables, charts, tables, quotes, tickers, summaries, numbers, text, or other information that may be static or interactive (e.g., hyperlinks, hover-over enabled, etc.).

The company data 1002 may include various amounts and types of data and information. For example, the company data 1002 may include information relating to the diversity of the company's executives. Information may be quickly retrieved for determining the sex, race, and other information associated with each of the executives to ensure that equitable recruiting, hiring, promotion, and compensation policies, standards, and practices are being implemented by each company. Any number of allowable metrics, factors, parameters, or other information may be utilized to display, search, or filter the company data 1002. As a result, the company data 1000 may be searched, sorted, and filtered using any number of formats.

In other embodiments, the company data 1002 may also include feedback for improving the diversity, equality, and inclusion factors, ratings, and scores associated with the company. For example, the company data 1002 may include feedback for changing recruiting and hiring processes, feedback on company demographics (e.g., board members, executives, employees/staff, vendors, contractors, etc.) for the entire company or by group (e.g., sales, marketing, engineering, support, accounting, etc.) for better diversity, equality, inclusion, social governance, environmental responsibility, and so forth. The feedback presented by the user interface 1000 may be associated with any number of metrics utilized to score, rank, and payment weighting the company data 1002 (e.g., corporate standards, policies, culture, implementations, etc).

The user interface 1000 may present one or more companies (e.g., names, tickers, abbreviations, etc.) are included in an index scoring and ranking companies by relevant company data as cited herein. Any number of reports, charts, tables, graphics, data, and other information may be presented utilizing the user interface 1000. In addition, the user interface 1000 may present information showing how the company data 1002 has changed for a specified time periods (e.g., week, month, quarter, year, all time, etc.).

The user interface 1000 enables enhanced transparency for company data 1002 for any number of investors/potential investors, investment groups, banks, monitoring groups, or so forth. The company data 1002 presented in any number of formats shows how the one or more companies in the United States or across the world are supporting historically disadvantaged individuals and groups for the betterment of society. The company data 1002 may be associated with companies of all sizes from large capitalization companies to small local family-owned businesses. Indices presented by the user interface 1000 may include companies that are added and removed at any time. The user interface 1000 may be utilized to compile information and data from members of various minority and demographic groups (e.g., voice of the crowd, written analysis and feedback, etc.) applicable to one or more companies.

The features, steps, and components of the illustrative embodiments may be combined in any number of ways and are not limited specifically to those described. For example, the description and figures for FIGS. 1-10 are applicable, combinable, and applicable in various contemplated combinations. In particular, the illustrative embodiments contemplate numerous variations in the smart devices and communications described. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the invention. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of embodiments for implementing the invention and is not intended to be limiting in scope. The following claims set forth a number of the embodiments of the invention disclosed with greater particularity.

What is claimed is:

1. A method for analyzing company data, comprising:
capturing source data regarding one or more companies utilizing a data platform;
analyzing the source data captured based on criteria including at least equality, diversity, and inclusion associated with the one or more companies to generate company data for each of the one or more companies;
scoring the one or more companies based on the criteria;
ranking the one or more companies based on the criteria; and
communicating the company information including at least the scores and ranking from the data platform to one or more designated parties.

2. The method of claim 1, wherein the source data is captured from a plurality of public resources and private resources.

3. The method of claim 1, further comprising:
storing the company data in a secure storage for access by authorized parties.

4. The method of claim 1, wherein the company data is accessible through a cryptocurrency token or non-fungible token.

5. The method of claim 1, further comprising
grouping the company data into a data asset;
associating the data asset with a data platform including one or more servers and databases;
receiving transaction information for the data asset;
performing one or more transactions for the data asset based on the transaction information, wherein the one or more transactions are performed utilizing the data platform; and
providing verification of the transaction for the data asset.

6. The method of claim 1, further comprising:
creating an index of at least a portion of the one or more companies based on the company data, the scoring, and the ranking.

7. The method of claim 1, further comprising:
providing feedback to the one or more companies to enhance equality, diversity, and inclusion in response to the scoring and the ranking.

8. The method of claim 7, wherein the feedback includes at least suggestions for hiring and promotions within the one or more companies.

9. The method of claim 1, further comprising:
searching the one or more companies in the data platform based on the company data.

10. The method of claim 1, further comprising:
automatically performing a transaction in response to the company data or changes to the company data.

11. The method of claim 1, wherein the communicating is performed in response to generating the company data or changes in the company data.

12. The method of claim 1, wherein the data platform is a trading platform for performing the one or more transactions, wherein the data platform communicates with a plurality of devices executing a mobile application in communication with the data platform.

13. A system for analyzing company data, comprising:
a data platform accessible by the plurality of wireless devices executing the data application through one or more networks, wherein the data platform captures source data regarding one or more companies utilizing a data platform, analyzes the source data captured based on criteria including at least equality, diversity, and inclusion associated with the one or more companies to generate company data for each of the one or more companies, score the one or more companies based on the criteria, rank the one or more companies based on the criteria, and communicate the company information including at least the scores and ranking from the data platform to one or more designated parties; and
a plurality of electronic devices executing a data application, the data application is configured to receive the company data for utilization.

14. The system of claim 11, wherein the data platform further:
stores the company data in a secure storage for access by authorized parties, and wherein the company data is accessed utilizing a cryptocurrency token or non-fungible token.

15. A data platform, comprising:
a server including a processor for executing a set of instructions and a memory for storing the set of instructions;
a plurality of databases in communication with the server configured to store data;
wherein the set of instructions are executed by the processor for the server to capture source data regarding one or more companies utilizing a data platform, analyze the source data captured based on criteria including at least equality, diversity, and inclusion associated with the one or more companies to generate company data for each of the one or more companies, score the one or more companies based on the criteria, rank the one or more companies based on the criteria, and communicate the company information including at least the scores and ranking from the data platform to one or more designated parties.

16. The data platform of claim 15, wherein the set of instructions are further executed to:
automatically perform a transaction in response to the company data or changes to the company data.

17. The data platform of claim 16, wherein the transaction is performed utilizing blockchain, and wherein the verification is recorded in a blockchain ledger.

18. The data platform of claim 15, wherein the set of instructions are further executed to:
provide feedback to the one or more companies to enhance equality, diversity, and inclusion in response to the company data.

19. The data platform of claim 15, wherein the set of instructions are further executed to:
group the company data into a data asset, associate the data asset with a data platform including one or more servers and databases, receive transaction information for the data asset, perform one or more transactions for the data asset based on the transaction information, wherein the one or more transactions are performed utilizing the data platform, and provide verification of the transaction for the data asset.

20. The data platform of claim 15, wherein the company data is accessible through a cryptocurrency token or non-fungible token.
